(19) United States
(12) Patent Application Publication
(10) Pub. No.: US 2021/0364862 A1
(43) Pub. Date: Nov. 25, 2021

(54) BACKLIGHT MODULE AND DISPLAY DEVICE

(71) Applicants: HEFEI BOE OPTOELECTRONICS TECHNOLOGY CO., LTD., Hefei, Anhui (CN); BOE TECHNOLOGY GROUP CO., LTD., Beijing (CN)

(72) Inventors: Jinmoo PARK, Beijing (CN); Hanqi CHU, Beijing (CN)

(73) Assignees: HEFEI BOE OPTOELECTRONICS TECHNOLOGY CO., LTD., Hefei, Anhui (CN); BOE TECHNOLOGY GROUP CO., LTD., Beijing (CN)

(21) Appl. No.: 16/339,889

(22) PCT Filed: Oct. 18, 2018
(86) PCT No.: PCT/CN2018/110742

§ 371 Date: Apr. 5, 2019

(30) Foreign Application Priority Data
Nov. 6, 2017 (CN) 201721466011.4

(51) Int. Cl. G02F 1/13357; F21V 8/00

(52) U.S. Cl. CPC G02F 1/133615; G02F 1/133608; G02B 6/0055; G02B 6/0088; G02F 1/133605

(57) ABSTRACT

A backlight module and a display device are provided by the present disclosure. The backlight module includes: a light guide plate including a light-emergent surface; and an optical film and a support structure arranged at a side of the light-emergent surface of the light guide plate; wherein the support structure is configured to support and fix the display panel.

### CROSS-REFERENCE TO RELATED APPLICATION

The present application claims the priority of the Chinese patent application No. 201721466011.4 filed in China on Nov. 6, 2017, a disclosure of which is incorporated herein by reference in its entirety.

### TECHNICAL FIELD

The present disclosure relates to the field of display technology, and in particular, relates to a backlight module and a display device.

### BACKGROUND

At present, a liquid crystal display (LCD) is a commonly used flat panel display. A backlight module is an important part of the liquid crystal display and is used to provide a light source for a liquid crystal panel in the liquid crystal display when the liquid crystal display is in operation.

With rapid development of smart phones, market requirements for performance and taste of the backlight module are increasingly high, and a backlight module having a high brightness, a narrow border, and an optimal image quality is required. In a narrow bezel structure of a conventional display device, a bezel of the backlight module needs to be narrow. That is, a distance from an active display region (an active area (AA)) of a liquid crystal panel to an edge of the backlight module needs to be reduced. Thus, a distance from an edge of the AA region to an edge of a light guide plate is required to be reduced. If the distance is too small, a strong light from a gap between the light guide plate and a mold frame may be seen under a large viewing angle, i.e., a light line under the large viewing angle. Furthermore, a bezel size of a narrow bezel is limited by a mold thickness of the mold frame.

### SUMMARY

Technical solutions provided by the present disclosure are described below.

A backlight module for providing a light source to a display panel is provided and includes a light guide plate including a light-emergent surface; and an optical film and a support structure, arranged at a side of the light-emergent surface of the light guide plate; wherein the support structure is configured to support and fix the display panel.

Further, the support structure is a support spacer.

Further, an edge of the light guide plate at least partially extends beyond an edge of the optical film, and the support structure is arranged on a portion of the light guide plate that extends beyond the optical film.

Further, the support structure is a plastic part made of a hard plastic.

Further, the support structure is a polyester resin part made of a polyester resin.

Further, the support structure is a light shielding structure having a preset light transmittance.

Further, the support structure is attached to the light-emergent surface of the light guide plate by pasting the support structure on the light-emergent surface of the light guide plate.

Further, a surface of the support structure facing away from the light guide plate is provided with a double-sided tape, the double-sided tape is configured to attach and fix the display panel.

Further, the backlight module further includes a back plate, the back plate includes a bottom plate portion and a side plate portion, the bottom plate portion is arranged at a side of a bottom face of the light guide plate, the bottom surface facing away from the light-emergent surface; and the side plate portion is arranged around the light guide plate.

Further, a reflector is arranged between the bottom plate portion and the bottom face of the light guide plate.

A display device is provided and includes a display panel and the backlight module, wherein an edge of the display panel is laminated on the support structure and is supported and fixed by the support structure.

### BRIEF DESCRIPTION OF THE DRAWINGS

In order to describe technical solutions of embodiments of the present disclosure more clearly, drawings used in the embodiments of the present disclosure will be described briefly below. It is apparent that the described drawings are related to a part of the embodiments of the present disclosure. Based on the described drawings of the present disclosure, other drawings may be obtained by those skilled in the art without paying any creative work.

FIG. 1 is a structural schematic view of a display device according to some embodiments of the present disclosure.

### DETAILED DESCRIPTION

In order to make objectives, technical solutions and advantages of the embodiments of the present disclosure clearer, the technical solutions of the embodiments of the present disclosure will be clearly and completely described below in conjunction with the drawings of the embodiments of the present disclosure. It is apparent that the described embodiments are a part, rather than all, of the embodiments of the present disclosure. Based on the described embodiments of the present disclosure, all other embodiments obtained by those skilled in the art fall within the scope of the disclosure.

In view of a problem in a related art that a narrow bezel display device may generate a bright line under a large viewing angle due to a small distance between an edge of a light guide plate and an edge of an active area of the display device, a backlight module and a display device are provided by the present disclosure, and through the backlight module and the display device provided in the present disclosure, an above-mentioned problem of the bright line under a large viewing angle may be addressed and a purpose of reducing a size of a bezel may be achieved.

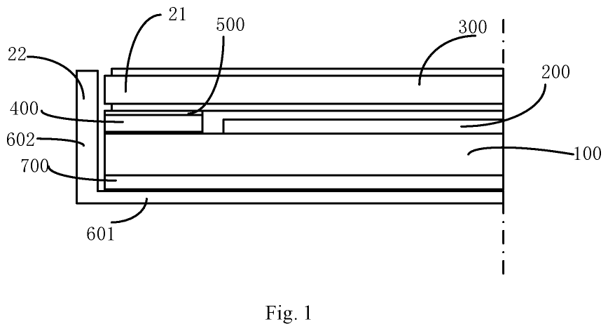

As shown in FIG. 1, a backlight module is provided in the present disclosure. The backlight module is configured to provide a light source to a display panel 300. The backlight module includes: a light guide plate 100 including a light-emergent surface; an optical film 200 arranged at one side of the light-emergent surface of the light guide plate 100; and a support structure 400 arranged at the one side of the light-emergent surface of the light guide plate 100, wherein the support structure 400 is configured to support and fix the display panel 300.

The backlight module provided by the present disclosure has a simple structure and is easy to be assembled, and the support structure 400 arranged on the one side of the light-emergent surface of the light guide plate 100 supports the display panel 300. In one aspect, the support structure 400 supports the display panel 300 as a structure part and may replace a mold frame in a conventional backlight module, so that a size of a bezel is not affected by a thickness of the mold frame, and the purpose of reducing the size of the bezel of the backlight module may be achieved; In another aspect, since the support structure 400 is arranged on the side of the light-emergent surface of the light guide plate 100 and replaces the mold frame, the edge of the light guide plate 100 may be extended outwardly, as compared with the conventional backlight module, so that sizes of the light guide plate 100 and the active area (AA) may be increased. Thus, the problem in the related art that the bright line under a large viewing angle caused by a too small distance between the edge of the light guide plate 100 and the edge of the active area in a narrow bezel structure may be addressed, and a display effect is improved.

As shown in FIG. 1, in some embodiments provided by the present disclosure, the support structure is implemented by using a support spacer. According to the above embodiments, the display panel is supported by arranging the support spacer on the light-emergent surface of the light guide plate 100, so that the structure of the display panel is simple, and a manufacturing process of the display panel and an assembly method of the display panel are simple. It should be understood that, in practical applications, the support structure 400 may not be limited to a structure of the support spacer, and may be implemented in other manners. For example, the support structure 400 may also be implemented by arranging a support protrusion on the light-emergent surface of the light guide plate and at a region corresponding to a peripheral region outside the display region of the display panel. The support protrusion may be integrally formed with the light guide plate. A specific implementation of the support structure will not be enumerated.

As shown in FIG. 1, in some embodiments of the present disclosure, the edge of the light guide plate 100 at least partially extends beyond an edge of the optical film 200, and the support structure 400 is arranged on a portion of the light guide plate 100 extended beyond the optical film 200.

According to the above embodiments, the edge of the light guide plate 100 extends outwards by a certain length, and the support structure 400 is arranged on an extending portion of the light guide plate 100, i.e., a portion of the light guide plate 100 that extends beyond the optical film 200. This structure is simple and easy to be assembled. Compared with the conventional backlight module, a conventional mold frame is replaced by the support structure 400, and the size of the bezel may be reduced by at least 0.45 mm as compared with the backlight module in the related art.

It should be understood that, in practical applications, the optical film 200 may also extend outwardly, and the support structure 400 may be arranged at the edge of the optical film 200.

In addition, in optional embodiments provided by the present disclosure, the support structure 400 is a plastic part made of a hard plastic. In case of the support structure 400 being the support spacer, the support spacer is a plastic spacer made of hard plastic.

According to the above embodiments, the support structure 400 is made of hard plastic, which may ensure a reliability of supporting and fixing the display panel 300. Optionally, the support structure 400 is a polyester resin part made of a polyester resin (PET) material. Of course, it should be understood that a specific material of the support structure 400 is not limited.

In addition, in the embodiments provided by the present disclosure, the support structure 400 is a light shielding structure having a preset light transmittance. According to the above solutions, the support structure 400 is arranged at the edge of the light-emergent surface of the light guide plate 100. If the light transmittance of the support structure 400 is too large, a light leakage problem may occur. If the support structure 400 is a totally opaque shielding structure such as a black structure, then since the black may absorb light, the light will be lost. Therefore, the support structure 400 is the light shielding structure having the preset light transmittance. For example, the support structure 400 is a gray light-transmissible spacer. Optionally, the preset light transmittance of the support structure 400 is about 15%, which may play a role of reducing light appearing at the edge of the light guide plate 100.

In addition, in some embodiments provided by the present disclosure, the support structure 400 is attached to the light-emergent surface of the light guide plate 100 by pasting the support structure 400 onto the light-emergent surface. In this way, the formed structure is simple and easy to be assembled. Of course, it should be understood that the manner in which the support structure 400 is fixed is not limited.

In addition, as shown in FIG. 1, in some embodiments provided by the present disclosure, a surface of the support structure 400 facing away from the light guide plate 100 is provided with a double-sided tape 500. The double-sided tape 500 is configured to attach and fix the display panel 300. According to the above solution, the display panel 300 is attached and fixed to the support structure 400 by using the double-sided tape 500, and the formed structure is simple and easy to be assembled.

In addition, as shown in FIG. 1, in some embodiments provided by the present disclosure, the backlight module further includes a back plate 600. The back plate 600 includes a bottom plate portion 601 and a side plate portion 602. The bottom plate portion 601 is arranged at a side of the light guide plate 100 facing away from the light-emergent surface, i.e., at a bottom surface of the light guide plate 100; and the side plate portion 602 is arranged around the light guide plate 100. A reflector 700 is arranged between the bottom plate portion 601 and the bottom face of the light guide plate 100.

In the above solutions, since a conventional mold frame is replaced by the support frame 400, the edge of the light guide plate 100 may be arranged to cling to the side plate portion 602 of the back plate 600, and there is no mold frame between the light guide plate 100 and the back plate 600.

In addition, a display device is provided by the embodiments of the present disclosure and includes a display panel 300 and the backlight module according to the embodiments of the present disclosure, wherein an edge of the display panel 300 is laminated on the support structure 400 and is supported and fixed by the support structure 400.

The above embodiments are merely optional embodiments of the present disclosure. It should be noted that numerous improvements and modifications may be made by those skilled in the art without departing from the principle of the present disclosure, and these improvements and modifications shall also fall within the scope of the present disclosure.

1. A backlight module for providing a light source to a display panel, comprising:
a light guide plate, comprising a light-emergent surface; and
an optical film and a support structure, arranged at a side of the light-emergent surface of the light guide plate;
wherein the support structure is configured to support and fix the display panel.

2. The backlight module according to claim 1, wherein, the support structure is a support spacer.

3. The backlight module according to claim 1, wherein, an edge of the light guide plate at least partially extends beyond an edge of the optical film, and the support structure is arranged on a portion of the light guide plate that extends beyond the optical film.

4. The backlight module according to claim 1, wherein, the support structure is a plastic part made of a hard plastic.

5. The backlight module according to claim 4, wherein, the support structure is a polyester resin part made of a polyester resin.

6. The backlight module according to claim 1, wherein the support structure is a light shielding structure having a preset light transmittance.

7. The backlight module according to claim 1, wherein, the support structure is attached to the light-emergent surface of the light guide plate by pasting the support structure on the light-emergent surface of the light guide plate.

8. The backlight module according to claim 1, wherein, a surface of the support structure facing away from the light guide plate is provided with a double-sided tape, the double-sided tape is configured to attach and fix the display panel.

9. The backlight module according to claim 1, wherein the backlight module further comprises a back plate, the back plate comprises a bottom plate portion and a side plate portion, the bottom plate portion is arranged at a side of a bottom face of the light guide plate, the bottom surface facing away from the light-emergent surface; and the side plate portion is arranged around the light guide plate.

10. The backlight module according to claim 9, wherein, a reflector is arranged between the bottom plate portion and the bottom face of the light guide plate.

11. A display device, comprising:
a display panel and the backlight module according to claim 1,
wherein an edge of the display panel is laminated on the support structure and is supported and fixed by the support structure.
